(19) United States
(12) Patent Application Publication
(10) Pub. No.: US 2012/0191499 A1
(43) Pub. Date: Jul. 26, 2012

(54) COMPETENCE BUILDING SYSTEM

(75) Inventor: Ravi Shankar Pillutla, Hyderabad (IN)

(73) Assignee: Tata Consultancy Services Limited, Mumbai (IN)

(21) Appl. No.: 13/245,526

(22) Filed: Sep. 26, 2011

(30) Foreign Application Priority Data
Jan. 22, 2011 (IN) 212/MUM/2011

(51) Int. Cl. G06Q 10/06

(52) U.S. Cl. 705/7.14

(57) ABSTRACT

Systems and methods for building competence in employees of an organization are described herein. In one implementation, a competence building system includes a deliverable definition module to identify a one or more deliverable slices associated with a work product based on a deliverable definition. The deliverable definition indicates a plurality of tasks that need to be completed for building the deliverable slices. Further, a competence identification module of the competence building system identifies a one or more competencies associated with the deliverable slices. Furthermore, the competence identification module identities a one or more resources to be provided to a one or more employee, wherein the employee possesses a minimum level of competence.

### CLAIM OF PRIORITY

This application claims the benefit of priority under 35 U.S.C. §119 of Ravi Shankar Pillutla, Indian Patent Application Serial Number 212/MUM/2011, entitled “COMPETENCE BUILDING SYSTEM,” filed on Jan. 22, 2011, the benefit of priority of which is claimed hereby, and which is incorporated by reference herein in its entirety.

### TECHNICAL FIELD

The present subject matter relates, in general, to a training system in an organization, and, in particular, to a competence building system in an organization.

### BACKGROUND

Organizations spend a lot of time and resources in building competencies of their employees selected for a particular job position. Such job positions may be specific to certain fields. For example, a software programmer may be selected for programming in the field of the job position. Various training systems and mechanisms are developed in order to build these competencies in the employees. Such training mechanisms and systems provide a structure for training the employees in the various fields as required by the organization.

The conventional training systems and mechanisms train and provide the knowledge of a certain field to the employee through training sessions conducted by experts. The employee subsequently applies that knowledge to perform the task related to the particular field for which the employee has been trained.

### SUMMARY

This summary is provided to introduce concepts related to building of competencies based on a work product, in employees of an organization. This summary is neither intended to identify essential features of the claimed subject matter nor is it intended for use in determining or limiting the scope of the claimed subject matter.

Systems and methods for building competence in employees of an organization are described herein. In one implementation, a one or more deliverable slices associated with a work product are identified based on a deliverable definition. The deliverable definition indicates a plurality of tasks that need to be completed for building the deliverable slices. Subsequently, a one or more competencies associated with the deliverable slices are identified. Furthermore, one or more resources to be provided to one or more employees are identified wherein the employee possesses a pre-defined level of competence.

### BRIEF DESCRIPTION OF THE; DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary network environment implementing a competence building system, in accordance with an implementation of the present subject matter.

FIG. 2 illustrates the competence building system, in accordance with an implementation of the present subject matter.

FIG. 3 illustrates an exemplary method to build competence in an employee of an organization, based on a deliverable slice, in accordance with the present subject matter.

### DETAILED DESCRIPTION OF THE DRAWINGS

The subject matter described herein relates to a competence building system for employees of an organization. The systems and methods, related to a competence building system, as described herein can be implemented in a variety of computing environments, such as in a mobile computing environment and a plurality of computing devices such as a server, a desktop personal computer, a notebook or a portable computer, a mainframe computer.

Various conventional training systems provide training for increasing the competencies of employees within the organization. Such conventional systems focus on providing the necessary knowledge to the employees for performing a variety of tasks. The employee applies the received knowledge onto a number of tasks to convert them to complete work projects. The conventional systems provide a plurality of on-job as well as classroom trainings to their employees in order to build the required competence for a job.

Conventionally, the training systems generate training material for the employees depending on factors, such as their job profile, past experience, etc. For example, a software engineer may be trained in Java programming for handling all the Java programming related projects. However, such sort of training does not ensure that the employee would be competent enough to handle real time projects and specific deliverables. This primarily arises as the training delivered for the employee may not be specific to or focused for certain work product also referred to as a deliverable, but is general and provides a broad level of understanding of the task at hand.

Additionally, in conventional systems, a person may be hired based on his experience, or his project certifications, etc. These parameters, simply assume the person to be competent in a specific field because of his prior experience in related fields. However, such conventional systems do not measure deliverable specific competencies of the employee. This leads to reduced quality of the work product, re-work and training for the deliverable, and consequently reduced productivity.

To this end, systems and methods for building competencies in employees of an organization are described. For this, a number of deliverable slices, that would constitute a work product (also referred to as a deliverable), are identified. A deliverable slice can be considered to be a part of the whole work product or the deliverable. The deliverable slice has its own requirement specification and a context in which it is applicable. Further, the deliverable slice requires a plurality of tasks (also referred to as process steps) to be completed in order to fulfill the requirements associated with that deliverable slice. These tasks for every deliverable slice, when collectively performed would constitute the process steps that would be required for the completion of the entire work product or the deliverable. For example, for a deliverable involving creation of a banking application, creation of a web-based user-interface can be considered to be one deliverable slice. Further, the tasks to be completed for completing the deliverable slice web based user interface, can be, creating HTML page, Java script validations, session management and so on.

In one implementation, a plurality of tasks can be grouped together to fulfill a specific requirement of the requirement specification of the deliverable slice, and such grouped tasks dictate the competencies required for building that deliverable slice. For the above example, in order to build the deliverable slice such as a web based user interface, the employee must have the competence for creating the HTML page, JavaScript validations, session management, etc.

In one implementation, the competencies with respect to the tasks as well as the deliverable slices are in a re-usable form. For example, creating an HTML page is a task and the competence for performing the task can be re-used in other similar kinds of deliverable slices like web based user interface, or login feature in the user interface. Similarly, the deliverable slices, such as building a web based user interface, can also be in a re-usable form which can be a part of one or more similar kinds of work products, like banking application, or a CRM-based application. Each deliverable slice of the entire work product or the deliverable is built by completing the set of tasks that correspond to certain quality characteristics defined in the requirements specification of the deliverable slice. Further, the completion of all the deliverable slices results in building of the entire work product or the deliverable.

In one implementation, the reusable deliverable slices can be determined based on a deliverable definition of the entire work product. In an implementation, such a deliverable definition can be defined by a project leader. The deliverable definition, amongst other things, may indicate the individual task definitions of a specific work product, such as what are the sub modules of the entire work product that can be completed individually. For example, the entire work product is divided into smaller modules until the smallest module which can not be further broken down is identified. These modules are also referred to as the deliverable slices. In one implementation, the deliverable definition can be predefined, and may vary with the nature and/or objective of the project. For example, for engineering a banking application, the deliverable definition may specify various functions in the form of deliverable slices that are associated with a banking application, say accounting, account verification, balance verification, web based user interface, database management. Once the deliverable slices associated with the project are identified, the deliverable slices can be further defined by the competencies associated with it. For example, the competencies can be in the form of the tasks that need to be performed in order to build a deliverable slice are identified and listed.

In one implementation, the various competencies required for building the various deliverable slices in order to further build the entire work product, are listed in a project competency menu. For the above example, for a deliverable banking application, the project competency menu may list the relevant competencies, such as creating a HTML page, java script validations, and database connection management.

Following the identification of the competencies required for all the deliverable slices in the work product or the deliverable, suitable employees are searched based on the identified competencies. In one implementation, the suitable employees can be identified from a database. In a further implementation, all the employees having a minimum level of competence are searched from the database. The identified employees are hereinafter referred to as candidate employees. Subsequently, all the searched candidate employees are assigned a specific rote based on the identified deliverable slices of the larger deliverable. For example, a candidate employee may be allocated a role of creating a web based user interface (deliverable slice) in the banking application (the larger deliverable). Therefore, the candidate employee is responsible for creating the web based user interface.

In a further implementation, all the competencies required by the candidate employees, based on the allocated role and the deliverable slice, are identified and listed in an employee competency menu. For example, for an employee working on creating a web based user interface, the employee competency menu will include competencies for building a hyper text markup language (HTML) page, building strut tags, javascript validations, etc. In one implementation, the employee competency menu provides the competencies mapped to a specific requirement of a deliverable slice, which indicate the process steps that need to be performed in order to build the deliverable slice.

Subsequently, a plurality of competency building assets are identified for building the required competencies in the candidate employees. In said implementation, the competency building assets are training materials and virtual project environments, which are aimed at training the candidate employees and building the required competencies in the employee based on the deliverable slices and the work product. In one implementation, competency building assets are stored in a database from where they can be extracted; however, if the competency building assets are not available for some competencies, then they can be created afresh.

In one implementation, the competency building asset is an executable asset for each competency and defines the understanding of the scope of the competencies. In a further implementation, the competency building asset can be divided into three portions. The first portion of the competency building assets contains the requirement definitions and the quality characteristics needed, corresponding to the competencies, and the deliverable slices. Further, the second portion of the competency building asset includes the detailed process steps or the tasks that a plurality of industry experts would use to execute in order to build the deliverable slice for the fulfillment of the associated requirements. Furthermore, the third portion of the competency building asset includes the time standards for executing the process steps, considering the practical realities and the project needs. For example, the time taken by an expert, the maximum time allowed for the employee to execute the process steps. In one implementation, the third portion of the competency building asset is also referred to as the acceptance criteria for a competency. Moreover, a precondition to the time compliance and the acceptance criteria is that all the process steps listed in the competency building asset are correctly executed.

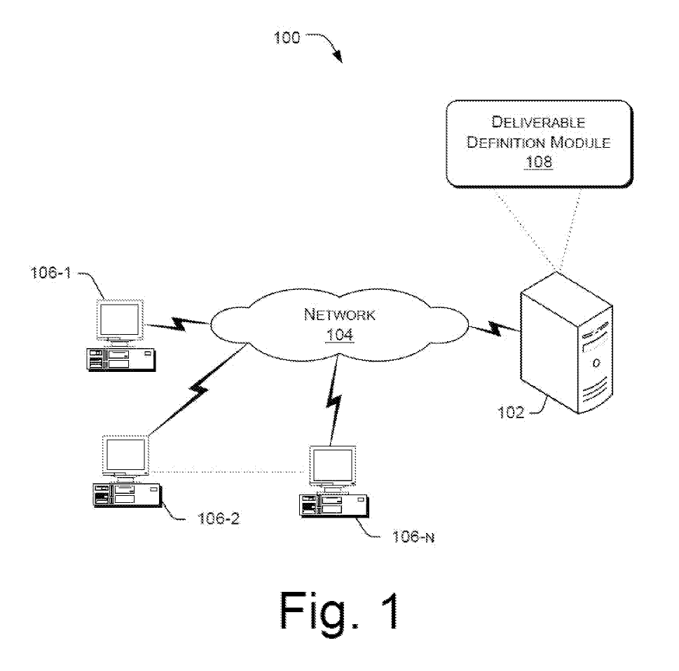

In an implementation, such competency building assets are executed by the candidate employees in order to gain or develop the desired competence for the deliverable slice and the work product. As would be appreciated by a person skilled in the art, the competence building system as described herein reduces the training time. Additionally, the resultant performance of the candidate employee in the competence building exercise and relevant project performance bears a high correlation. These and other aspects of the present subject matter are described in detail in conjunction with FIGS. 1-3. While aspects of systems and methods can be implemented in any number of different computing systems environments, and/or configurations, the embodiments are described in the context of the following exemplary system architecture(s).

FIG. 1 shows an exemplary network environment 100 implementing a competence building system 102 for building competencies in the employees of an organization. The competence building system 102 as described herein develops competence in the employees based on a specific work product also referred to as a deliverable. In one implementation, the network environment 100 includes the competence building system 102, communicating through a network 104 with the various client devices 106-1, 106-2, to 106-N, hereinafter collectively referred to as client devices 106. The competence building system 102 further includes a deliverable definition module 108.

The network 104 may be implemented as a wireless network, wired network or a combination thereof. The network 104 can be implemented as one of the different types of networks, such as intranet, local area network (LAN), wide area network (WAN), the internet, etc. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 104 may include network devices, such as network switches, hubs, routers, HBAs, for providing a link between the competence building system 102, and the client devices 106. The network devices within the network 104 may interact with the competence building system 102, and the client devices 106 through communication links.

The competence building system 102 and the client devices 106 can be implemented as any of a variety of computing devices including, for example, servers, a desktop computer, a notebook or portable computer, a workstation, a mainframe computer, a mobile computing device, an entertainment device.

In operation, a deliverable definition module 108 of the competence building system 102 receives one or more deliverable definitions of a specific work product. In one implementation, the deliverable definitions can either be configured by a user or can be generated based on a work product received from a client. As mentioned previously, deliverable definition provides one or more individual task definitions that may form a part of the specific work product. In one implementation, the deliverable definitions can be used for identification of various competencies required for completing a specific work product. Once the deliverable definitions are identified, the deliverable definition module 108 of the competence building system 102 generates reusable deliverable slices based on the deliverable definitions. For example, a deliverable definition corresponding to constructing a banking application may include deliverable slices such as retail banking module, credit banking module and the like. Further, another deliverable slice can be building a web based user interface. In one implementation, the deliverable slices can be generated by the competence building system 102 using an Offering Competence Mapping (OCM) tool.

Further, in one implementation, the competence building system 102 identifies the competencies that the employees of an organization require to complete the desired deliverable at a desired level of quality. For this, the deliverable definition further defines a set of process steps or tasks that need to be executed in order to build the deliverable slice. These set of tasks define the competencies that are required by the employees in order to build the deliverable slices. In one implementation, all the competencies required by various deliverable slices in the work product are listed in a project competency menu. The project competency menu indicates a mapping of the competencies to the deliverable slices of the work product.

Further, the competence building system 102 identifies one or more employees having a threshold amount of competencies, based on the deliverable definition. In one implementation, the employees can be searched from a database or other similar repositories stored external or internal to the competence building system 102. These searched employees are hereinafter referred to as candidate employees. Further, the competence building system 102 allocates specific roles to the candidate employees based on the identified deliverable slices and the required competencies. For example, a candidate employee may be assigned a role of building a web based user interface (deliverable slice) for the banking application (deliverable). Therefore, the candidate employee is responsible only for the role assigned to him, and the employee must possess all the competencies required for the deliverable slice and the role allocated to him. In a further implementation, the competencies of an employee based on the allocated role, are listed in an employee competency menu.

Once all the competencies required for every deliverable slice, the entire work product and the candidate employees are identified, the competence building system 102 searches and extracts a plurality of relevant competency building assets that are to be provided for building the identified competencies in the candidate employees. For example, the competence building assets can be pre-stored in a database. In a further implementation, if the competence building system 102 does not find any relevant competence building asset in the database, then the relevant competence building assets can be created afresh.

Subsequently, the competence building system 102 executes the extracted competence building assets in order to develop the desired competence in the candidate employees. In one implementation, the competence building asset comprises of three portions. A first portion of the competency building asset contains the requirement definitions corresponding to the competencies and the deliverable slices. Further, a second portion of the competency building asset includes a set of detailed process steps or the tasks that a plurality of industry experts would execute in order to build the deliverable slice for the fulfillment of the associated requirements. Furthermore, a third portion of the competency building asset includes the time standards for executing the process steps, considering the practical realities and the deliverable needs. For example, the time taken by the employee is compared with the time taken by an expert, or the maximum time allowed for the employee to execute the process steps. In one implementation, the third portion of the competency building asset is also referred to as the acceptance criteria for a competency. Moreover, a precondition to the time conformance and the acceptance criteria, is that all the process steps listed in the competency building asset are correctly executed.

It will be appreciated that the competency building assets are aimed at training the candidate employees for a desired competence and developing the desired competence in the candidate employees. In a further implementation, the competency building asset can be in the form of training resources like a virtual environment for executing the deliverable slice, templates, mock tests, and study materials. In one implementation, the training once completed, can be further assessed or evaluated. Based on the evaluation, the competence building system 102 can further suggest additional training or can provide an indication that the candidate employee possesses a threshold amount of competence and is capable of providing the deliverable slice with a desired level of quality.

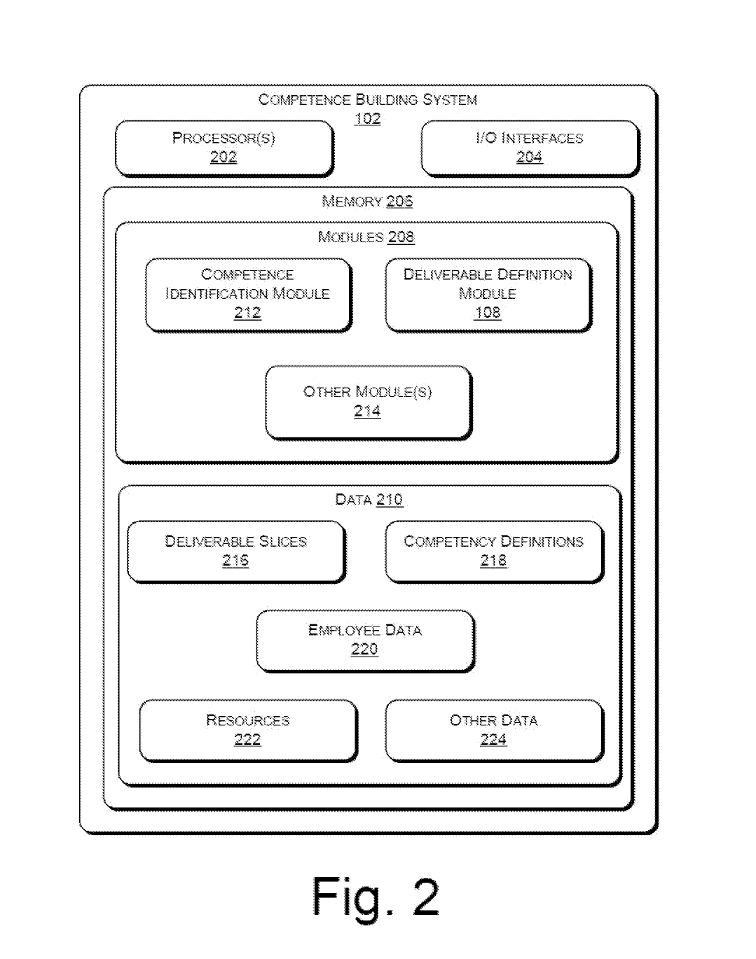

In a further implementation, the performance of the candidate employee during the training can be compared to that of an expert. For example, one of the parameters for comparison can be the time taken to do the task by the individual versus that of the expert, as set in the third portion of the competency building assets. Also, the acceptance criterion may vary from one competence to another and from one project deliverable slice to another. For example, if the employee performs the task in less or equivalent time and of equivalent quality as that of an expert, then the candidate employee is said to meet the acceptance criterion. In case the candidate employee fails to meet the acceptance criteria, another employee can then be selected based on their performance and/or assessment made during training. In a yet another implementation, in case the candidate employee fails to meet the acceptance criterion, he can iteratively take the training until he meets the acceptance criterion. In one implementation, once the candidate employee meets the acceptance criteria, he can be certified as a competent employee for providing the deliverable slice with a desired level of quality. These and other aspects are explained in detail in conjunction with FIG. 2.

FIG. 2 illustrates a competence building system 102, in accordance with an embodiment of the present subject matter. In said embodiment, the competence building system 102 includes a processor 202, I/O interface(s) 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions stored in the memory 206.

The I/O interface(s) 204 may include a variety of software and hardware interfaces, for example, a web interface allowing the competence building system 102 to interact with the client devices 106. Further, the interface(s) 204 may enable the competence building system 102 to communicate with other computing devices, such as web servers and external repositories or databases. The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of client devices 106 to each other or to another server.

The memory 206 can include any computer-readable medium known in the art including, for example, volatile memory (e.g., RAM), and/or non-volatile memory (e.g., EPROM, flash memory, etc.). The memory 206 includes one or more module(s) 208 and data 210. In one embodiment, the module 208 further includes a competence identification module 212, the deliverable definition module 108, and other module(s) 214.

The data 210 serves, amongst other things, as a repository for storing data processed, received and generated by the one or more of the module(s) 208. The data 210 includes, for example, deliverable slices 216, competency data 218, employee data 220, resources 222, and other data 224. In an example, the deliverable slices 216, the competence data 218, the employee data 220 and the resources 222, may be stored in the memory 206 in the form of data structures.

In operation, the competence building system 102 receives information describing the work product (hereinafter referred to as a deliverable) to be completed by the employees of the organization. It will be appreciated that systems and methods described in the present description can be used for increasing the competencies of other personnel, such as trainees, members who are on probation, etc., and not restricted to employees of an organization only.

The information in relation to the entire work product can be received in the form of deliverable definitions. The deliverable definitions, amongst other aspects, indicate the various individual tasks and functionalities that are required to be implemented for completing the deliverable. The deliverable definition module 108 receives the deliverable definitions. In one implementation, the deliverable definitions can be specified as an extensible markup language (XML) file listing the various tasks that form part of the deliverable work product that is related to the deliverable definitions. In one implementation, the deliverable definitions can be stored in other data 224.

In further implementation, the deliverable definition module 108 divides the entire work product into one or more deliverable slices 216. The deliverable slices 216 can be further divided into deliverable sub-slices, and so on. In said implementation, every deliverable slice has a plurality of requirement specifications associated with it. Furthermore, every deliverable slice requires a plurality of tasks to be completed in order to fulfill the requirement definition associated with that deliverable slice. These tasks for every deliverable slices, when collectively performed would constitute the process steps that would be required for the completion of the entire work product. These tasks individually indicate the competencies that define the deliverable slices 216. In said implementation, the competencies are stored in the form of competency data 218. For example, ‘Create Login Page’ is a deliverable slice for the entire work project web based banking applications. Therefore, the deliverable slice 216 involving creation of a login page would be defined by a plurality of competencies 218 like building Hyper Text Markup Language (HTML) Page, building strut tags, JavaScript validations and some tasks like input hard code data, compile the code etc.

The deliverable definition module 108 on receiving the deliverable definitions and the deliverable slices 216, obtains the reusable competency data 218 based on the received deliverable definitions. In one implementation, the deliverable definition module 108 parses through the deliverable definitions to generate the deliverable slices 216 which, in turn, map to competencies 218. As indicated previously, the competency data 218 indicate a set of reusable tasks that have their own standalone requirements. The competency data 218 can be considered as tasks that are to be performed at the lowest level of granularity. In that case, tasks corresponding to such competencies 218 can be such that they are also applicable to other similar deliverables. For example, competencies 218 corresponding to web-page designing would be applicable for a variety of work products, such as banking applications, CRM-based applications, etc.

In said implementation, the competencies 218 indicates the competencies that are required by an employee working for the desired work product and its deliverable slice 216. For example for a deliverable slice “creating a web page” a specific competence pertaining to HTML based web creation is required by the employee. It should be noted that similar to the deliverable slices 216, the competencies 218 may also be standalone. Moreover, each of the competencies 218 will necessarily have identified requirements corresponding to the deliverable slices 216.

In one implementation, the deliverable slices 216 and the competency data 218 are defined using an Offering Competence Mapping (OCM) tool. An exemplary Offering Competence Map is shown below as Table 1. For the relevant work product, one or more deliverable slices 216 can be identified. In another implementation, the deliverable definition module 108 can receive the deliverable definitions in the form of an XML or other compatible manner. In such a case, the deliverable definition module 108 can parse through the XML to determine the relevant deliverable slices, and store the same as deliverable slices 216.

In a further implementation, all the competencies 218 for the various deliverable slices 216 of the entire deliverable are listed in a project competency menu. The project competency menu may be stored in other data 224.

TABLE 1

| Entire Work | Deliverable | Individual Tasks/Competencies | | | |
|---|---|---|---|---|---|
| Product | Slices | GUI | Action Handler/DD | Middle Tier | Back-End |
| Banking | Login and | Create | Session management | Password | Query to |
| Application | | HTML | | encryption/decr | validate login |
| | | Javascript | Service integration | Database | Dynamic menu |
| | | validations | | connection | generated from |
| | | JSP Tags | Redirection to | Exception | |
| | | | appropriate view | handling | |
| | | Struts tags | Exception handling | Connection | |
| | | in JSP | | leakage | |
| | | JSTL/Core | Filters | | |
| | | tag | | | |
| | | libraries | | | |
| | | Post | Role declaration | | |
| | | method | in DD | | |
| | | | URL Patterns in DD | | |
| | Create/Save | Create | Capture request | Database | Query/stored |
| | new | HTML | parameters and | connection | procedure to |
| | Data | page | populate DTO as | management | insert |
| | | | required by service | | data |
| | | JavaScript | Reading | Exception | Throw |
| | | validations | property files | handling | exception in |
| | | JSP Tags | Session management | keeping | Dynamic |
| | | | | database | form fields |
| | | | Service integration | Connection | |
| | | | | leakage | |
| | | | Exception handling | | |
| | | | Redirection to | | |
| | | | appropriate view | | |

In a further implementation, the competence identification module 212 identifies one or more employees having a threshold amount of competencies based on the received work product, the identified deliverable slices 216 and the identified competencies 218. Further, the competence identification module 212 allocates one or more roles to the identified candidate employees. For example, an employee may be allocated a role of user interface designer, which indicates that the employee is responsible only for the deliverable slice 216 involving user interface design for the web based banking application. Therefore, based on the role allocated to the employee, a plurality of competencies 218 are also identified for the employee. For example, for the deliverable slice 216 user interface design, the employee must possess the competencies for creating a HTML page, javascript validations, and session management. Further, the competencies needed by every employee are listed in an employee competence menu which is stored in the employee data 220.

The identified candidate employees may be subjected to a variety of resources for building or enhancing their competencies. The competence identification module 212 determines the resources that would be required for building or enhancing the competencies of the candidate employees. In one implementation, the competence identification module 212 searches for the relevant resources within the resources 222. The resources 222, amongst other things, may include a one or more competency building assets that would be instrumental for building or enhancing the competencies of the candidate employees. The resources 222 may include material that can either be instruction based or can be assessment based. Examples of instruction based resources include, but are not limited to, training manuals, textbooks, instructions, etc. As is described earlier, the competency building assets include process steps that an expert would use for realizing one or more requirements that are associated with the deliverable slices 216. Also the competency building assets include the acceptance criterion as set in accordance with the performance of the expert. The competence identification module 212 selects the relevant material from resources 222 based on the identified competencies 218.

The materials selected from the resources 222 can then be provided to the candidate employees. The candidate employees can go through the material for increasing their competencies. The level of the competencies 218 of the candidate employees can further be assessed to determine whether the employees possess the desired level of competencies to ensure a quality work product. In one implementation, the competence identification module 212 can periodically or systematically assess the change in the competencies of the candidate employees as a result of providing the materials selected from resources 222. In one implementation, resources 222 can also be located externally to the competence building system 108, such as an external data store.

In one implementation, the competence identification module 212 can also provide the candidate employees with competency building assets to simulate the tasks that the employees are likely to face while completing a deliverable work project. In one implementation, the competence identification module 212 can evaluate the performance of the candidate employees with respect to certain benchmark parameters. The benchmark parameters can be the performance of an expert during such test cases. Depending on relative performance of the candidate employees with respect to the performance of the expert, the employees can be considered to meet the acceptance criteria and possess the required competencies for completion of the deliverable work product. In a further implementation, the candidate employee can be trained iteratively until he meets the acceptance criteria. In one implementation, the candidate employee can be certified on meeting the acceptance criteria.

It will be appreciated by a person skilled in the art the training resources provided for the candidate employees would be specific to the granular requirements that were associated with the deliverable slices 216. Furthermore, the candidate employees were also selected based on the granular requirements associated with the deliverable slices 216. In such a case, since the selection of the candidate employees and the selection of the material from resources 222 is based on the deliverable slices 216, the competence building of the candidate employees is more focused and is likely to build or enhance the competencies of the employees at an increased rate. The resultant performance of the candidate employee in the competence building exercise and relevant project performance bears a high correlation.

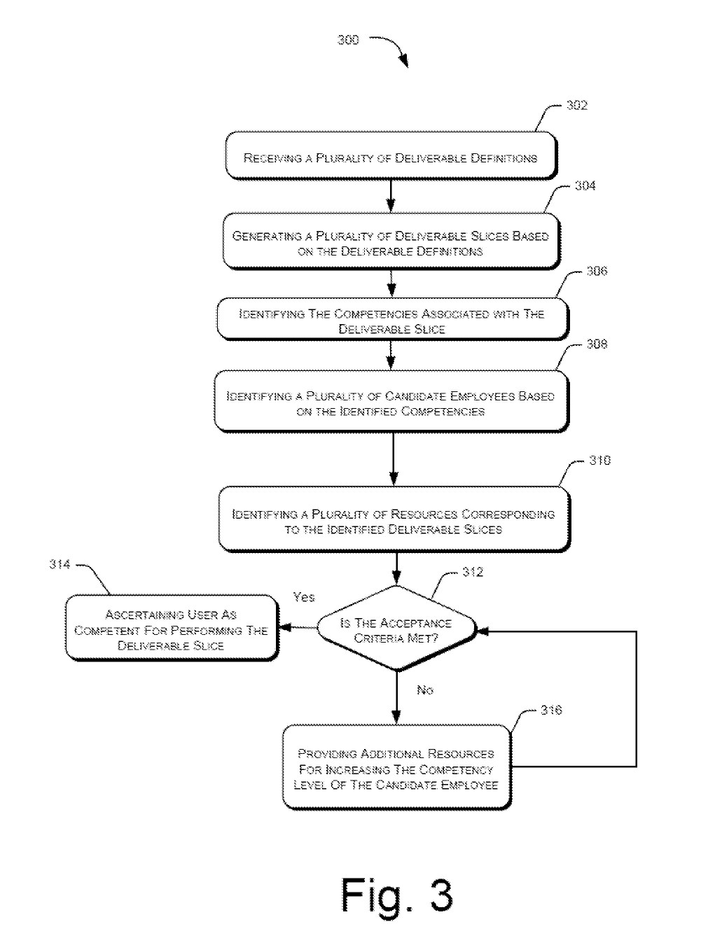

FIG. 3 illustrates an exemplary method 300 for building competence in an employee of an organization, in accordance with the present subject matter. The exemplary method 300 may be described in the general context of computer executable instructions. The method 300 may be a computer implementable method. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communication network. In a distributed computing environment, computer executable instructions may be located in both local and remote computer storage media, including memory storage devices.

The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or a combination thereof.

In accordance with one embodiment of the present subject matter, the method 300 may be implemented in the previously described competence building system 102. However, it will be appreciated by one skilled in the art that such an implementation is not limiting.

At block 302, a deliverable definition is received. For example, the competence building system 102 receives deliverable definitions. In one implementation, a deliverable definition module 108 receives a plurality of deliverable definitions. As indicated previously, deliverable definition provides one or more individual task definitions that may form a part of a specific work product (also referred to as a deliverable). In one implementation, the deliverable definitions can be stored in the other data 224. In another implementation, the deliverable definitions can be in the form of an XML file.

At block 304, a plurality of deliverable slices are identified based on the deliverable definitions. For example, deliverable definition module 108 identifies the plurality of deliverable slices, stored as deliverable slices 216, based on the received deliverable definitions of the work product. As described earlier, the deliverable slices 216 can be considered as integrated sets of tasks that are intended to meet specific requirement definitions in a context and have related qualities defined. The deliverable slices 216 are to be performed at the lowest level of granularity and are generally in a reusable form. In one implementation, the deliverable slices 216 can be generated based on an OCM tool.

Further, at block 306, competencies associated with the identified deliverable slices are determined. For example, competence identification module 212 identifies the required competencies associated with one or more of the deliverable slices 216. In one implementation, the competencies can be identified based on competency data 218. The identified competencies can be considered to be the competencies that the employees must have, to successfully complete the task requirements of the identified deliverable slices. In a further implementation, the competencies identified for the entire work product are listed in a project competency menu which is stored in the other data 224.

At block 308, a plurality of employees are identified based on the identified competencies and the identified deliverable slices. For example, the competence identification module 212 identifies one or more employees within an organization based on employee data 220. The identified employees are those that are most likely to possess the required competencies in order to meet the work requirements of the deliverable slice, such as the ones associated with the deliverable slices 216. In one implementation, the competence building system 102 list the identified employees in the order of their competencies. Based on a threshold number, or a number as selected by a user, finite number of candidate employees can be chosen for building or enhancing their competencies. Further, a specific role based on the deliverable slices 216 is allocated to the candidate employees. For example, a candidate employee may be allocated a role of creating a web based user interface which is a deliverable slice 216 of the entire work project. Subsequently, the competencies required by the employee based on the allocated role, are listed in an employee competency menu. The employee competency menu is further stored in the employee data 220. In one implementation, the candidate employees can be identified based on a listing of the plurality of competencies that are required for the project defined as competencies menus. The competencies menus will include a combined and unique list of competencies that all different roles defined for one or more employees must possess in order to deliver the requirements of the project. As would be appreciated, that such competencies would be derived from the identified deliverables of the project and the deliverable slices it comprises of.

At block 310, a plurality of resources corresponding to the identified deliverable slices and the identified competencies, are determined. For example, the competence identification module 212 determines the resources that would be required for building or enhancing the competencies of the candidate employees. In one implementation, the competence identification module 212 searches for the relevant resources within the resources 222. The resources 222, amongst other things, may include material that would be instrumental for building or enhancing the competencies of the candidate employees. Examples of such materials include, but are not limited to, a plurality of executable competency building assets in the form of virtual environments for executing the deliverable slices, mock tests, questionnaires, manuals, quizzes. The resources 222 can be also be prepared by a number of industry experts. The content of the resources 222 can be so chosen so as simulate the tasks that the candidate employees are more likely to face during the course of completing a deliverable work product.

At block 312, it is determined whether the identified candidate employees meet an acceptance criterion or not. For example, the competence identification module 212 provides the employees with the materials, such as tests, selected from the resources 222. The competence identification module 212 further determines whether the employees meet an acceptance criterion, based on an assessment of the performance of the employee, say in the test. The competence identification module 212, depending on the performance of the candidate employees, say during the tests, can determine the employees which meet the acceptance criteria. In further implementation, the extracted resources are used to present mock environments such as mock tests, study materials etc., to the employee.

If the user is found to meet the acceptance criteria (‘Yes’ path from block 312), the user is considered to possess the required competencies for completing a desired deliverable slice for the work product (block 314). For example, if on a time bound exercise if the candidate employee performs the task correctly in a lesser time as compared to an expert, the candidate employee would be considered to meet the acceptance criterion. In one implementation, the candidate employee is a certified employee set to be competent for providing the deliverable slice with a desired level of quality.

If on the other hand, it is determined that one or more of the identified candidate employees do not meet the acceptance criteria (‘No’ path from block 312), additional resources are provided to the employees for increasing their respective competencies as is shown in block 316. For example, the competence identification module 212 can, on an assessment, further provide material selected from resources 222. The method then proceeds to block 312 where a further evaluation is made to determine whether the employees have met the acceptance criteria. For example, the competence identification module 212 can continue the assessment of the employees for a fixed number of cycles, or till the time the performance of the candidate employees meet the acceptance criteria.

Although embodiments for competence building have been described in language specific to structural features and/or methods, it is to be understood that the invention is not necessarily limited to the specific features or methods described. Rather, the specific features and methods are disclosed as exemplary implementations for competence building.

I/We claim:

1. A system for building competence, wherein the system comprising:
a processor; and
a memory coupled to the processor, the memory comprising,
a deliverable definition module configured to,
identify at least one deliverable slice based at least in part on a deliverable definition, wherein the deliverable definition is indicative of a plurality of tasks; and
a competence identification module configured to,
identify one or more competencies associated with the at least one deliverable slices; and
identify, based on the identified one or more competencies, at least one resource for providing to at least one candidate employee, wherein the at least one candidate employee possesses a minimum level of competencies.

2. The system as claimed in claim 1, wherein the competence identification module is further configured to identify the at least one candidate employee based in part on the generated at least one deliverable slice.

3. The system as claimed in claim 1, wherein the competence identification module is further configured to assess competencies of the at least one candidate employee based in part on the at least one resource provided to the at least one individual.

4. The system as claimed in claim 3, wherein the competence identification module is further configured to assess competencies based in part on a performance of the at least one candidate employee.

5. The system as claimed in claim 3, wherein the competence identification module identifies a certified candidate employee based on determining the at least one candidate employee to meet an assessment criteria.

6. The system as claimed in claim 1, wherein the at least one resource comprises assessment based material and instruction based material.

7. The system as claimed in claim 1, wherein the deliverable definition module is further configured to parse the at least one deliverable definition to generate the deliverable slices.

8. A method for competence building, the method comprising:
receiving at least one deliverable definition;
identifying at least one deliverable slice based on the received deliverable definition, the at least one deliverable slice indicative of at least one task involved in implementing the at least one deliverable slice;
identifying one or more competencies, required for delivering the at least one deliverable slice, based on the at least one deliverable slice; and
identifying at least one candidate employee with a minimum level of competence, the identifying based on the identified one or more competencies.

9. The method as claimed in claim 8, wherein the deliverable definition is provided by a user.

10. The method as claimed in claim 8, further comprising providing one or more resources to the at least one candidate employee based on the deliverable slice.

11. The method as claimed in claim 8, further comprising assessing the at east candidate employee based on the providing.

12. The method as claimed on claim 8, further comprising:
continuously determining whether the minimum level of competence of the at least one candidate employee meets a threshold acceptance criteria; and
recursively providing one or more resources to the at least one candidate employee based on the continuously determining.

13. The method as claimed in claim 8, further comprising identifying at least one certified candidate employee based at least in part on comparing the minimum level of competence with a threshold level of competence.

14. A computer-readable medium having a set of computer executable instructions that, when executed, perform acts comprising:
receiving at least one deliverable definition from a user;
identifying at least one deliverable slice based on the received deliverable definition, the at least one deliverable slice indicative of at least one task involved in implementing the at least one deliverable slice;
identifying one or more competencies, required for delivering the at least one deliverable slice, based on the at least one deliverable slice;
identifying at least one candidate employee with a minimum level of competence, the identifying based on the identified one or more competencies; and
providing one or more resources to the at least one candidate employee based on the at least one deliverable slice.
